(19) United States
(12) Patent Application Publication
(10) Pub. No.: US 2010/0207478 A1
(43) Pub. Date: Aug. 19, 2010

(54) TIP-LOCATED AXIAL-GAP (TAG) MOTOR/GENERATOR

(75) Inventor: Sudarshan Paul Dev, Ashburn, VA (US)

Correspondence Address: Perman & Green, LLP, 99 Hawley Lane, Stratford, CT, 06614, US

(73) Assignee: D-STAR ENGINEERING CORPORATION, Ashburn, VA (US)

(21) Appl. No.: 12/702,060

(22) Filed: Feb. 8, 2010

Related U.S. Application Data
(60) Provisional application No. 61/150,638, filed on Feb. 6, 2009.

(51) Int. Cl. H02K 21/24

(52) U.S. Cl. 310/156.34

(57) ABSTRACT

A motor or generator having a rotor comprising an outer peripheral ring and having round bar permanent magnets with an axial length smaller than a diameter of the magnets embedded into the ring. The stator surrounding the motor and the stator comprising a stationary ring having a substantially flat sheet ring configuration including electrical conductors therein. The rotor comprises a flux-transfer ring rotating substantially as a unit with the outer peripheral ring. The flux transfer ring being substantially flat and facing the flat sheet ring.

### CROSS-REFERENCE TO RELATED APPLICATION(S)

This application claims the benefit of U.S. Provisional Application No. 61/150,638 filed Feb. 6, 2009 which is incorporated by reference herein in its entirety.

### FIELD

The exemplary embodiments disclosed therein are in the field of electric motors and generators.

### BRIEF DESCRIPTION OF EARLIER DEVELOPMENTS

‘Hybrid-electric’ is not just a fashionable buzz-word: it is the realization of a long-held dream of combining the high power and light weight of engines with the flexibility of electrical power transfer, to achieve enhanced efficiencies in various modes of operation of ground and air vehicles. Hybrid electric drives are to mechanical gear-and-shaft drives what quartz crystal watches are to the old pendulum driven watches: better quality at lower costs of all kinds, be they the financial cost of purchase, machinery weight, precision or reliability.

For an Uninhabited Air Vehicle (UAV), use of electric motors, with high power density and high specific power, can enhance the flexibility of operations in either all-electric or hybrid-electric mode, achieve stealthier flight when needed, and achieve greater system efficiency in a hybrid-electric mode.

For larger systems, both vertical take-off and landing (VTOL) UAVs as well as helicopters and manned Vertical or Short Take-Off and Landing (V/STOL) aircraft, use of electric drives for lift/thrust fans can replace heavy, inefficient and extremely maintenance-intensive gearboxes and drive shafts. Similarly, electric fans located at the extremities of the air vehicle can provide attitude control of the air vehicle while avoiding power transfer by mechanical transmissions or pressurized gas ducts. The result can be a lighter and more compact lift management system. Finally, electric motors can be provided current from lithium polymer batteries or ultra capacitors for emergency reserve power and lift.

In summary, electric power transmission can reduce the complexity and maintenance needs of mechanical drives for multi-fan lift systems. Use of electric lift/thrust fans and electric wheel motors, connected to a common power source in a hybrid-electric arrangement, may even enable Transformer Air Ground Vehicles (TAGVs), also known as ‘flying cars’. Electric motors/generators and power transfer systems, if able to achieve high specific power (power/weight), high power density (power/volume) and high efficiency may thus be an enabling technology that will finally make the ultimate personal transportation a reality.

### BRIEF DESCRIPTION OF DRAWINGS

The foregoing aspects and other features of the exemplary embodiment are explained in the following description, taken in connection with the accompanying drawings, wherein:

FIG. 1 is a schematic isometric view of a number of exemplary vehicles incorporating features in accordance with exemplary embodiments described herein;

FIGS. 2A-2B are respectively elevation and plan views of a motor/generator in accordance with a first exemplary embodiment;

FIGS. 2C-2E are respectively partial plan, partial cross sectional elevation and enlarged partial cross-section of a tip portion of the motor generator shown in FIGS. 2A-2B;

FIGS. 3A-3B are respectively elevation and plan views of a motor/generator in accordance with another exemplary embodiment;

FIGS. 4A-4B are respectively elevation and plan views of a motor/generator in accordance with another exemplary embodiment;

FIGS. 4C-4C are respectively partial perspective and cross-sectional views of a tip portion of the motor/generator shown in FIGS. 4A-4B;

FIGS. 5A-5B are schematic views of windings in accordance with an exemplary embodiment; and

FIGS. 6A-6B are schematic views of winding in accordance with another exemplary embodiment.

### DETAILED DESCRIPTION OF EXEMPLARY EMBODIMENTS

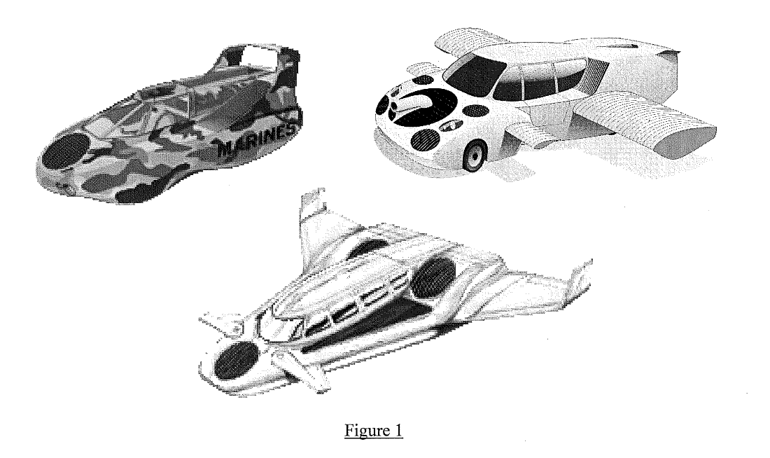

Referring to FIG. 1, small, one-seat and two-seat military V/STOL aircraft can probably have adequate control with one engine-driven lift/thrust fan and a parachute-based Ballistic Recovery System as used on small aircraft. Larger V/STOL aircraft, and those with commercial applications, will probably find greater acceptance if they have multiple engines and fans for redundancy.

One challenge for multi-engine V/STOL systems is stability and control in case of one or more engines becoming dysfunctional. For various prior systems such as helicopters and even ducted fan systems, this redundancy has been achieved through mechanical coupling of the lifting rotors, via numerous shafts and gears. While fairly reliable, these mechanical power transfer systems suffer from excessive weight, short maintenance intervals and restrictive configurations. Further, mechanical systems often have critical paths wherein a single point of failure can cause a loss of the whole system. For example, if a fan drive is damaged by bird ingestion or bearing failure, mechanical cross-coupling to other fans in the vehicle will not enable continued flight.

Also, mechanical coupling becomes exponentially more complex as the number of fans increases, such as when auxiliary fans are used for lift augmentation or for engine-out stability & control. Finally, a Transformer Air/Ground Vehicle (TAGV) may use power transfer between fans in flight, and to wheels on the ground, adding another layer of mechanical transmissions.

An alternative to mechanical coupling and power transmission is electrical coupling and transmission, either to entirely replace the mechanical systems of gears and shafts, or to supplement a partial system of gears and shafts. For example, a TAGV may have three gas-driven lift-thrust fans, each coupled to the other by mechanical shafts and gears.

Each lift/thrust fan may also have TAG Motor/Generators (described later), each coupled electrically to the other lift/thrust Fans as well as to TAG Motors on Auxiliary Fans located elsewhere in the TAGV and to wheel motors on the TAGV. Thus, if there is a mechanical jam in the shaft system, the fans can auto-disconnect through torque-limited frangible couplings, and yet provide for torque transfer through electrical means. Also, each TAG Motor/Generator of each Lift Fan may be electrically coupled to one or more Auxiliary Fans that balance the pitch and roll moments of the Lift Fan. Thus, mechanical damage to that Lift Fan will cause the balancing Auxiliary Fans to also lose power, reducing gross lift but maintaining stability while the other Lift Fans and engines spool up to produce more power and greater lift.

This electrical power transfer may be effected if electrical motors/generators achieve for example specific power values half- to one-order of magnitude (3×-10×) greater than available from the best systems today. This is proposed to be achieved by the TAG Motors/Generators in accordance with the exemplary embodiments as described further below.

The TAG Motors/Generators will thus be a key enabler for multi-engine and hybrid-electric transformer air/ground vehicles (TAGVs).

The TAG Motor (Tip-Located Axial Gap Motor) provides an increase in the power density and specific power by the desired half-an-order of magnitude beyond that achieved previously by either conventional Ring Motors or conventional Pancake Motors, and also reduces losses below those previously reported.

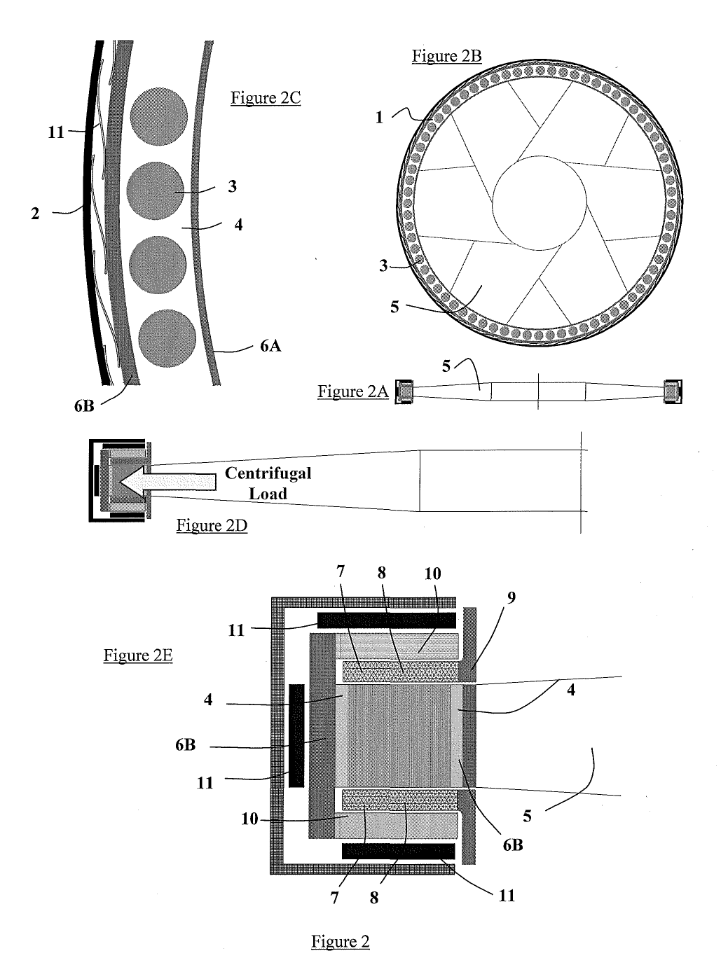

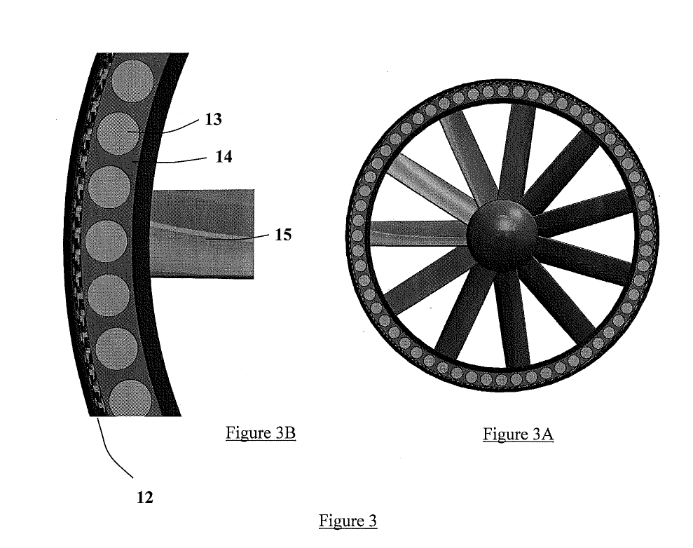

An exemplary embodiment of the TAG motor is illustrated in FIGS. 2A-2E and is described below. Another exemplary embodiment of the TAG motor is illustrated in FIGS. 3A-3B, and is described below.

FIGS. 2A-2E show an exemplary embodiment of the Tip-located Axial Gap (TAG) Motor/Generator with a rotor, 1, located within a stator, 2, having a large number of small, round permanent magnets, 3, embedded in a ring shaped matrix, 4, located at the tips of fan blades, 5. The ring in which the magnets are embedded (substantially evenly distributed around the circumference of the ring) may be made of a matrix material such as epoxy, and the magnets may be of the Nd-Fe-B type for the greatest value of BH (magnetic product). In alternate embodiments, the magnets may be distributed in groups or other suitable manner.

With reference again to FIG. 2E, an exemplary embodiment of the motor/generator has filament-wound structural sleeve(s), 4, integrated with the motor/fan rotor (in the exemplary embodiment shown, the motor rotor may be integrated to a fan rotor) to resist centrifugal loads, both from magnets and from fan blades.

The structural sleeves allow optimally high tip speed for lift/thrust fan applications. A low-pressure lift fan of 1.05:1 pressure ratio, with isentropic tip-work coefficient=0.2, has tip speed=470 ft/sec. A high pressure lift/thrust fan, of 1.4:1 pressure ratio typical of large aircraft turbofans, has tip speed=1250 ft/sec. The high tip speeds provide a direct, almost linear improvement in motor specific power output (hp/lb).

The structural sleeves also enable very high rim speeds, with correspondingly high operating voltages and extremely high specific power values. For a specific power level, higher operating voltages allow a reduction in current, which greatly reduces resistive (i2R) losses and enhances efficiency.

Alternatively, for rim speeds limited by fan tip speeds, a lighter structure can be used to hold the magnets in against centrifugal loads, and for better utilization of the flux-return iron.

Further, the structural sleeves enable the fan blades in the interior region of the TAG motor to have radial compressive (rather than tensile) loads, which can reduce notch sensitivity of the fan blades, and allow lighter construction of the fan blades.

With reference again to FIGS. 2A and 2D, an exemplary embodiment of the motor/generator has planar-symmetric construction, in the axial sense, with the magnet mid-plane as the plan of symmetry. Axially balanced loads due to planar-symmetric construction result in virtual elimination of the axial loads on bearings imposed by the magnetic forces.

Conventional axial flux machines, with small inner radius and large outer radius (pancake motors) induce disk-pumping of air by friction, and thus have high aerodynamic windage losses at high speeds. This is greatly reduced by a very small radial thickness of the TAG Motor, by use of a large number of small magnets and a ring-shaped architecture. The small windage losses do perform a useful function by cooling the faces of the copper machined-plate armatures.

With reference again to FIG. 2E, an exemplary embodiment of the motor/generator has thin, fine-machined copper stator disks, 7, in front of and behind (in an axial sense) the magnets, 3, with toroidal windings, 8, formed within the copper stator discs, such that the windings are substantially normal to axial flux lines of permanent magnets, 3. The copper windings, 8, are connected into electrical power circuits via conductor leads, 9. The windings between the magnets and the flux-circulation rings may be printed circuit type, or stamped from a copper sheet, or EDM'd (electron discharge machined) from copper sheets, or may be wire wound.

The toroidal copper windings on flat, thin sheet-like rings will have relatively low copper losses and greatly reduce cost compared to wire-windings and even copper sheets in the form of thin hollow cylinders. The toroidal copper windings on flat, thin sheet-like rings will also offer increased copper volume within the same overall dimensions, and thus offer increased power density and specific power. For a given current, the greater packing density of copper can help reduce the i2R losses.

With reference again to FIG. 2E, an exemplary embodiment of the motor/generator has thin rotating disks, 10, that co-rotate with the magnets, 1, said disks being in front of and behind stators, in an axial sense, to act as motor ‘back iron’ and complete the magnetic flux path.

Because the entire magnetic circuit rotates, there are no alternating magnetic fields in the flux-return rings, eliminating the iron losses of conventional permanent magnet motors. In typical motors, the iron losses (magnetic hysteresis) are larger than the copper losses (electrical resistance). The TAG motor eliminates the larger of the two groups of losses. Further, because the iron losses are frequency-dependent and the copper losses are not, this eliminates the magnetic speed limitation of the motors.

In the exemplary embodiment, the TAG motor/generator may use Neodymium-Iron Boron Permanent Magnets. Nd—Fe—B magnets have high values of the Maximum Energy Product, (BH)max, in the 24-54 MGOe range, significantly higher than 18-30 MGOe range for other high-quality magnetic materials such as SaCo.

It is worth noting that, for fan-tip applications, 350K (80C) temperature limits of Nd—Fe—B magnets corresponds to the total temperature of fan exit airflow after a pressure ratio of 1.8:1 at sea level standard conditions; the fan exit total temperatures are even lower at higher altitudes. By contrast, lift fans for V/STOL UAVs and aircraft have a fan pressure ratio that is optimal around 1.05:1, and even the fans for aircraft cruising at high-subsonic speeds is only about 1.4:1. These low-disk-loading fans can thus efficiently use NdFeB magnets for gains in power/weight ratio of the motors.

Motors that use Permanent Magnets have intrinsically high efficiency due to lack of losses in the field windings. Efficiency of motors is further enhanced by eliminating the iron (hysteresis) losses, due to the magnetic flux-return path co-rotating with the permanent magnets. The only remaining losses then are copper losses in the armature windings, and a small amount of aerodynamic ‘windage’ losses.

An embodiment of the TAG motor/generator may use a large number (such as for example 48 or 72 magnets for a 12 inch outer diameter motor, magnet number may be varied more or less, as suitable with smaller or larger outer diameter of motor) of magnets, as well as have high rotational speed. The large pole count and high speed of the rotor may produce a fundamental frequency in the range of several kHz. In order to generate quality waveforms in this frequency range, the inverter switching frequency in the 100 kHz range or higher may be desired. By way of example, MOSFETS and VJ-FETs allow adequately high switching frequencies with low switching losses.

Features of this motor, as shown in the exemplary embodiments, include being located at or near the tip of a ducted fan, as may be desired for V/STOL UAVs. Also the location of the motor at the large diameter, for a specific rotational speed, increases the surface speed at the air gap. This increases the operating voltage and increases power density (power/volume) and increases specific power (power/weight) for the motor. For a given power, the greater voltage allows a reduction in current, which in turn reduces the resistive losses through the copper circuit. This increases motor efficiency.

As described before, in the exemplary embodiment, he magnetic circuit rotates together with the magnets. This eliminates the hysteresis losses associated with alternative magnetic fields in a non-rotating flux return circuit. This further enhances efficiency.

The motor/fan has a very compact axial length, (e.g. for example the aspect ratio between motor outer diameter to axial length may be 5:1 or larger) with precise control of the gap distance, for smaller gap distances and hence greater power density and greater efficiency.

Efficient cooling of the copper windings, because the radial magnetic faces induce ‘disk’ pumping of air past the faces of the copper coils.

In greater detail and with reference still to FIGS. 2A-2E, the motor or generator of the exemplary embodiment shown has a rotor, 1, within a housing, 2, with an even number of permanent magnets, 3, distributed around the rotor periphery, and a fan, 5, for pressurizing a fluid or generating thrust, said magnets being embedded within a matrix, 4, with strengthening rings 6A and 6B outside the fan blades and outside the matrix holding the magnets. The magnets may have flat surfaces that face forward and aftward in an axial sense, the axes of said magnets being substantially parallel to the axis of rotation of said rotor, with the poles of adjoining magnets facing opposite directions.

The motor or generator may be configured so that the permanent magnets are cylindrical bar magnets. The motor or generator may have the two opposite ends or poles of the rotating magnets, 3, face two stationary flat ring-shaped structures, 7, of an electrically conductive material. The conductive rings may have for example mechanically, electrically or chemically machined passages, or passages that are made for example by depositing conductive materials, such as copper, on non-conductive material, such as printed circuit board, leaving behind or forming solid regions in the flat rings that act as electrical conductors, 8, to carry current in directions that are substantially radial or substantial normal to both the magnetic lines of flux created by the magnets and the tangential direction of movement of the magnets.

The motor or generator may have for example the flat conductive rings with their axial faces, opposite to the faces that are closest to the magnets, in close proximity to flat ring-shaped faces of a flat ring-shaped structure, that co-rotates with the magnets, and that is made of a material that has high magnetic permeability to form flux return paths for the motor or generator. The motor or generator for example may have the flux return paths predominantly in the circumferential direction. The motor or generator for example may have the shroud has a fiber-reinforced ring radially outside the magnets to provide strength against centrifugal forces acting on the magnets. The motor or generator for example may have the flat flux-return or flux-transfer ring radially surrounded by a filament-wound ring to provide strength against centrifugal loads in the flux-return ring. The magnetic permeable material of the flux-transfer ring may be shaped (as will be described further below) to conform to the magnetic flux generated by the magnets in the rotor. The motor or generator for example may have the entire rotor is supported by air foil bearings, 15, in the rim region of the rotor.

In another embodiment, a vehicle (such as shown in FIG. 1) may have more than one motors or generators as in any of the above embodiments wherein at least one of the motors or generators acts as a generator and at least one of the motors or generators acts as a motor, with electrical power transfer from the generator to the motor, with the intervention of a electronic power transfer system.

FIGS. 3A-B and 4A-4C illustrate motors or generators in accordance with other exemplary embodiments, for example where the architecture of the tip region of the TAG motor or generator may have, which consists of magnets embedded in a thin, flat spinning ring on a central plane, facing thin, flat stationary rings, 17, that function as armatures, 18, the outer faces of the armature rings facing thin, flat rings, 20, with embedded shaped iron pieces, 21, or other suitable high magnetic permeability materials that convey the magnetic flux in a tangential direction, thereby completing the co-spinning magnetic circuit, with flux passing through the stationary armatures. The flux-return rings 17, may have the magnetic permeable material, such as the shaped iron 21, shaped to conform or complement the flux of the magnets in the rotor ring. The shaped iron pieces 21 may be optimized for minimum weight by having iron where desired to carry the flux between adjoining magnets, but having a light-weight matrix (such as for example epoxy resin) rather than iron where the flux values would normally be low even if the matrix was replaced by iron.

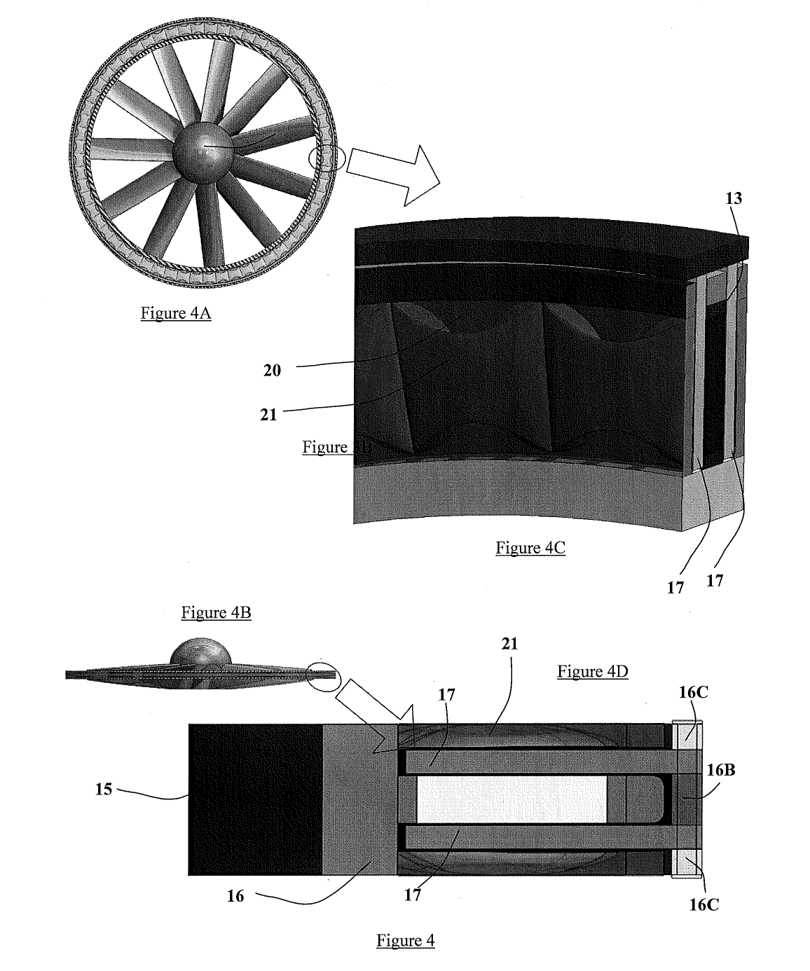

With reference again to FIGS. 3 and 4, the rotating rings, 14, carrying the magnets, 13, and the flux-transfer rings, 20, with the shaped iron magnetic material, 21, have fiber-reinforced structural rings, 16B, 16C and 16D, that help support the magnets and the irons against centrifugal forces. The high relative speed of the moving magnetic circuit and the stationary electrical circuit yields high power with low weight.

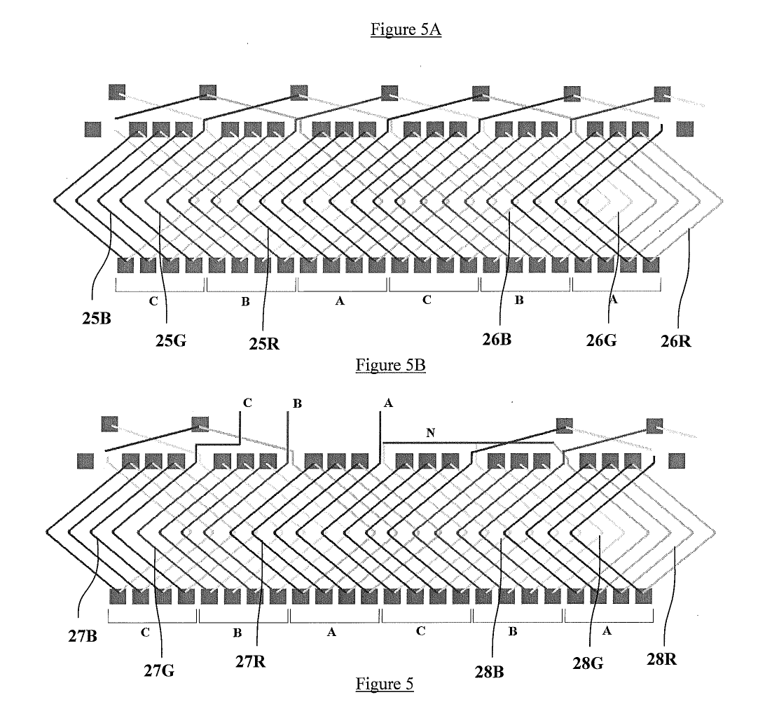

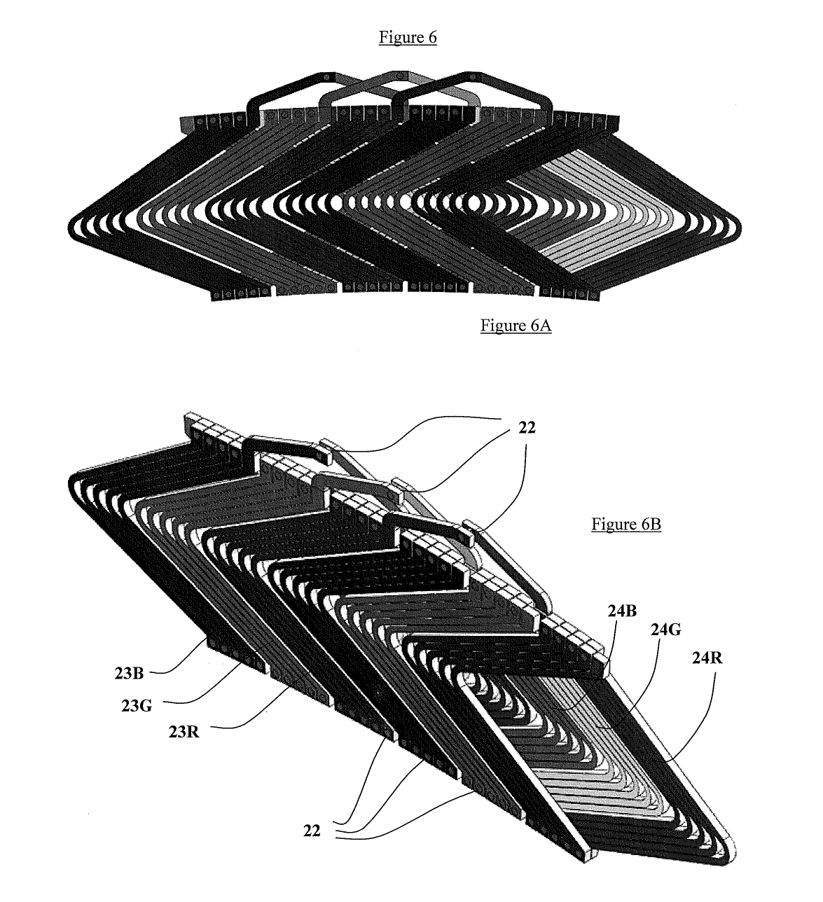

Referring now to FIGS. 5A-5B and 6A-6B, illustrate the design of the copper architecture, for a 3-phase permanent magnet motor/generator. [In these two figures, curved rims are shown as straight, for representational purposes].

With reference to FIGS. 5A-5B, the there may be three electrical phases of the copper conductors, referred to by A, B and C, connected in sequence to the common electrical ground or neutral, referred to by N. Further, in FIGS. 5A-5B (25B, 25G, 25R) and (27B, 27G, 27R) represent the top or front layer and (26B, 26G, 26R) and (28B, 28G, 28R) represent the bottom or back layer of the copper conductors.

With reference to FIGS. 6A-6B, small pins or interconnects, 22, also known as vias, connect selected terminals of the upper or front layer 23 to other selected terminals in the lower or back layer 24. Similar to the embodiment shown in FIGS. 5A-5B, (23, 23G, 23R) represent the top or front layer of the windings and (24B, 24G, 24R) represent the bottom or back layer.

Current flows through all turns of one phase at one pole and then moves on to the next pole, making a full circle where it reaches neutral. From neutral, it makes a full circle in the opposite direction then flows back out. All turns are in series and all poles are in series.

To minimize weight and cost of the armatures, the copper armatures are to be fabricated using bi-layer Printed Circuit Board Technologies, with ‘vias’, 22, connecting the conductors in the two layers, a top or front layer, 23, and a bottom or back layer, 24.

The windings are shown as having a general “chevron” or “diamond” pattern though in alternate embodiments the windings may have any suitable shape. The exact angles shown are for illustration only: given a certain application configuration would be optimized for the proportions. Beyond the simple proportions it is possible to design different patterns such as a straight bias, sinusoids, elliptical segments, etc. The width, thickness, and number of conductors per phase are also parameters to be optimized. Here the illustrations show a “wye” winding, but the armature could also be wound as “delta”, the other standard 3-phase architecture.

A feature of the windings of the TAG motor is the use of skin effect, wherein the high frequencies resultant from high rotational speed and high pole count force the current to flow on the outside surface, or skin, of the copper traces or conductors. This enables the use of less amount of copper, for weight and cost benefits, while retaining the ability of the motor/generator to use or provide the needed current for the desired power level, with similar losses.

In accordance with an exemplary embodiment a motor or generator is provided. The motor or generator may have a rotor comprising an outer peripheral ring and having round bar permanent magnets with an axial length smaller than a diameter of the magnets embedded into the ring. The stator surrounding the motor and the stator comprising a stationary ring having a substantially flat sheet ring configuration including electrical conductors therein. The rotor comprises a flux-transfer ring rotating substantially as a unit with the outer peripheral ring. The flux transfer ring being substantially flat and facing the flat sheet ring.

In accordance with another exemplary embodiment a motor or generator is provided. The motor or generator has a rotor and an outer peripheral ring having round bar permanent magnets embedded in the ring and a stator substantially surrounding the rotor, the stator comprising a stator ring having a substantially flat sheet ring configuration with flat sheet windings formed therein.

In accordance with yet another exemplary embodiment a motor or generator is provided, having a rotor comprising an outer peripheral ring having round bar permanent magnets with an axial length smaller than a diameter of the magnets embedded into the ring. A stator surrounding the motor and the stator comprising a stationary ring having a substantially flat sheet ring configuration including electrical conductors therein. The rotor comprises a flux-transfer ring rotating substantially as a unit with the outer peripheral ring. The flux transfer ring has a magnetically permeable material disposed conformally with corresponding flux distribution of the magnets from the outer peripheral ring.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A motor or generator comprising:
a rotor comprising an outer peripheral ring having round bar permanent magnets, with an axial length smaller than a diameter of the magnets, embedded into the ring;
a stator surrounding the motor, the stator comprising a stationary ring having a substantially flat sheet ring configuration including electrical conductors therein; and
wherein the rotor comprises a flux-transfer ring rotating substantially as a unit with the outer peripheral ring, the flux transfer ring being substantially flat and facing the flat sheet ring.

2. The motor or generator in accordance with claim 1 wherein the outer peripheral ring comprises a reinforcing ring periphery.

3. The motor or generator in accordance with claim 1 wherein the outer peripheral ring is sized and shaped to encompass an axial fan within the ring.

4. The motor or generator in accordance with claim 1 wherein the rotor has an aspect ratio between peripheral ring outer diameter and axial length of 8.

5. A motor or generator comprising:
a rotor comprising an outer peripheral ring having round bar permanent magnets embedded in the ring; and
a stator substantially surrounding the rotor, the stator comprising a stator ring having a substantially flat sheet ring configuration with flat sheet windings formed therein.

6. The motor or generator in accordance with 5 wherein the outer peripheral ring is sized and shaped to encompass an axial fan within the ring.

7. The motor or generator in accordance with claim 5 wherein the rotor has an aspect ratio between peripheral ring outer diameter and axial length of 8.

8. The motor or generator in accordance with claim 5 wherein the flat sheet windings are formed by machining the flat sheet ring.

9. The motor or generator in accordance with claim 5 wherein the flat sheet windings are formed by chemical etching.

10. A motor or generator comprising:
a rotor comprising an outer peripheral ring having round bar permanent magnets, with an axial length smaller than a diameter of the magnets, embedded into the ring;
a stator surrounding the motor, the stator comprising a stationary ring having a substantially flat sheet ring configuration including electrical conductors therein; and
wherein the rotor comprises a flux-transfer ring rotating substantially as a unit with the outer peripheral ring, the flux transfer ring having a magnetically permeable material disposed conformally to corresponding flux distribution of the magnets from the outer peripheral ring.

11. The motor or generator in accordance with claim 10 wherein the outer peripheral ring is sized and shaped to encompass an axial fan within the ring.

12. The motor as in claim 10 wherein the rotor has an aspect ratio between peripheral ring outer diameter and axial length of 8.
